(19) United States
(12) Patent Application Publication
(10) Pub. No.: US 2012/0135365 A1
(43) Pub. Date: May 31, 2012

(54) INTRAORAL ORTHODONTIC CORRECTOR

(76) Inventor: James D. Cleary, Glendora, CA (US)

(21) Appl. No.: 13/384,260

(22) PCT Filed: Aug. 11, 2010
(86) PCT No.: PCT/US10/45102

§ 371 Date: Jan. 16, 2012

Related U.S. Application Data
(60) Provisional application No. 61/235,448, filed on Aug. 20, 2009.

(51) Int. Cl. A61C 7/36; A61C 7/28

(52) U.S. Cl. 433/10; 433/19; 433/24

(57) ABSTRACT

Provided are orthodontic corrector devices, related assemblies and methods which direct forces within the oral cavity. These corrector devices and assemblies include a flexible cantilever which is coupled to both a connector component and a force module. The cantilever acts to isolate adjacent components from mastication forces encountered during treatment. By resiliently deflecting in response to these inadvertent forces, the cantilever reduces the likelihood of device breakage and bond failure. Upon removal of these forces, the cantilever returns to its original orientation thereby maintaining the proper alignment of the corrector. Advantageously, the cantilever also allows the force module to be positioned further in the distal direction thereby enabling a greater range of connection options.

### BACKGROUND OF THE INVENTION

1. Field of the Invention

Orthodontic devices, assemblies and methods are provided for use in orthodontic treatment. More particularly, orthodontic corrector devices, along with related assemblies and methods, are provided for directing therapeutic forces between dental structures within the oral cavity.

2. Description of the Related Art

The field of orthodontics relates to the supervision, guidance and correction of teeth towards proper positions in the oral cavity. Orthodontic therapy generally involves the application of forces to move teeth into a proper bite configuration, or occlusion. One mode of therapy, known as fixed appliance treatment, is carried out using a set of tiny slotted appliances called brackets, which are affixed to the anterior, cuspid, and bicuspid teeth of a patient. In the beginning of treatment, a resilient orthodontic appliance known as an archwire is received in each of the bracket slots. The end sections of the archwire are typically anchored in appliances called buccal tubes, which are affixed to the patient's molar teeth.

When initially installed in the brackets and buccal tubes, the archwire is deflected from its original arcuate (or curved) shape, but then gradually returns to this shape during treatment. In this manner, the archwire applies gentle, therapeutic forces to move the teeth from improper positions to proper positions. Taken together, the brackets, buccal tubes, and archwire are commonly referred to as “braces”. Braces are often prescribed to improve dental and facial aesthetics, bite function and dental hygiene.

During certain stages of treatment, additional intraoral appliances may be prescribed for use in conjunction with fixed appliances to correct particular kinds of malocclusions. For example, some appliances are used to correct Class II malocclusions, such as an overbite where the mandibular first molars are located excessively distal (in the rearward direction) with respect to the maxillary first molars when the jaws are closed. Other appliances remedy an opposite malocclusion, known as a Class III malocclusion, such as an underbite where mandibular first molars are located excessively mesial (in the forward direction) with respect to the maxillary first molars when the jaws are closed.

In recent years, Class II and Class III correctors have been developed that are installed by the orthodontist and require minimal patient intervention during the course of treatment. These devices advantageously correct Class II and Class III malocclusions without need for patient compliance. Moreover, there are various possibilities in connecting these devices to the dental arch. Banded headgear tubes are still commonly used to provide a distal connection to the upper dental arch. These banded appliances, however, are not universally used. Bondable molar appliances are more convenient to use in many respects and some orthodontists prefer them over banded appliances. As another option, connection to the dental arch may be made indirectly by coupling the intraoral device to one or both archwires. Accordingly, manufacturers have sought to configure these intraoral devices with the versatility to work with a wide variety of appliances.

### BRIEF SUMMARY OF THE INVENTION

Provided herein is an intraoral orthodontic corrector, along with related assemblies and methods, that direct corrective forces to dental structures while displaying substantially improved robustness during the course of treatment.

While prior art devices have attempted to connect intraoral appliances to bonded appliances, these efforts often exposed their vulnerabilities to breakage or bond failure as a result of mastication (biting) forces inadvertently transmitted to the appliance. The risk of bond failure is also generally higher in these situations since bonded appliances tend to be significantly weaker than their banded counterparts. Moreover, these prior art devices tend to use couplings that provide a high degree of pivotal freedom between adjacent components. While these couplings advantageously allow normal jaw movement by the patient, these same couplings can also be problematic in at least two other ways.

First, the freedom provided by the coupling can allow portions of the device to inadvertently pivot into the occlusal areas. This, in turn, can result in the patient biting down on the device thereby causing bond failure, device breakage and/or painful contact of the device with the oral tissues of the patient. Second, even if the device is kept safely away from the occlusion, the couplings can still bind or jam when misaligned or otherwise knocked out of position by hard food objects and the like. When this occurs, the biting force can become transmitted directly to the coupling and again cause device breakage or bond failure.

The provided orthodontic corrector overcomes these problems by including a flexible cantilever that isolates adjoining device components from the brunt of these biting forces. By resiliently flexing, or deflecting, in response to inadvertent forces placed on the device, vulnerable components of the device are protected. When these forces are subsequently removed, the cantilever returns to its original orientation and thereby maintains the proper alignment of the corrector. As an additional advantage, the cantilever can allow the position of the force module to be extended toward the distal direction and enable a greater range of connection options between the force module and the dental arch.

In one aspect, the present invention is directed to an orthodontic corrector for applying therapeutic forces between an upper arch appliance and a lower arch appliance comprising a connector for coupling to the upper arch appliance of a patient, a cantilever rigidly coupled to the connector, the cantilever comprising a resilient material having sufficient memory to self-return the cantilever to a certain, pre-determined orientation when relaxed, and a force module having two opposing ends, with one end coupled to the cantilever and the opposite end adapted for coupling to the lower appliance.

In another aspect, the invention is directed to an orthodontic assembly comprising a set of brackets, an archwire connected to the brackets, a connector coupled to the archwire, a cantilever rigidly coupled to the connector and comprising a resilient material having sufficient memory to self-return the cantilever to a certain, pre-determined orientation when relaxed, and a force module coupled to the cantilever.

In still another aspect, the invention is directed to a method of applying forces between first and second orthodontic appliances located on opposing jaws of a patient comprising providing a connector, the connector rigidly attached to one end of a cantilever comprising a resilient material having sufficient memory to self-return the cantilever to a certain, pre-determined orientation when relaxed, the other end of the cantilever being pivotally attached to a force module, coupling the connector to the first appliance, and coupling the force module to the second appliance, wherein the cantilever flexibly maintains at least a portion of the force module in a location that is fixed relative to the connector.

### DEFINITIONS

As used herein:

“Mesial” means in a direction toward the center of the patient's curved dental arch;

“Distal” means in a direction away from the center of the patient's curved dental arch;

“Occlusal” means in a direction toward the outer tips of the patient's teeth;

“Gingival” means in a direction toward the patient's gums or gingiva;

“Facial” means in a direction toward the patient's lips or cheeks;

“Lingual” means in a direction toward the patient's tongue.

### BRIEF DESCRIPTION OF THE SEVERAL VIEWS OF THE DRAWINGS

FIG. 1 is a side view of an orthodontic assembly according to one embodiment of the invention installed on a dental arch;

FIG. 2 is an exploded facial view looking at the lingual side of an orthodontic corrector shown in the assembly of FIG. 1;

FIG. 3 is an enlarged facial view looking at the lingual side of a connector shown in FIG. 2 except that the connector is shown in an orientation as it appears before assembly to a cantilever of the corrector;

FIG. 4 is a mesial view of the connector in FIG. 3;

FIG. 5 is a gingival view of the connector in FIGS. 3 and 4;

FIG. 6 is a reduced fragmentary gingival view of the orthodontic corrector in FIG. 2;

FIG. 7 is a view somewhat similar to FIG. 4 except that the connector is shown as it appears when assembled to the cantilever of FIG. 3;

FIG. 8 is an exploded facial view of an orthodontic corrector according to another embodiment of the invention;

FIG. 9 is an enlarged mesial view of a connector shown in the corrector of FIG. 8;

FIG. 10 is a fragmentary gingival view of the orthodontic corrector in FIG. 8;

FIG. 11 is mesial view of the orthodontic corrector in FIGS. 8 and 10.

### DETAILED DESCRIPTION OF THE INVENTION

The present disclosure relates to orthodontic devices, correctors, and assemblies that apply therapeutic forces to dental structures during the course of treatment. Exemplary embodiments of these devices, correctors, and assemblies shown herein are useful for treatment of Class II malocclusions. However, these should not be deemed to unduly limit the invention. For example, these embodiments could also be adapted for use in treating class III malocclusions. Alternatively, these embodiments could be adapted for use within either the upper or lower arch individually.

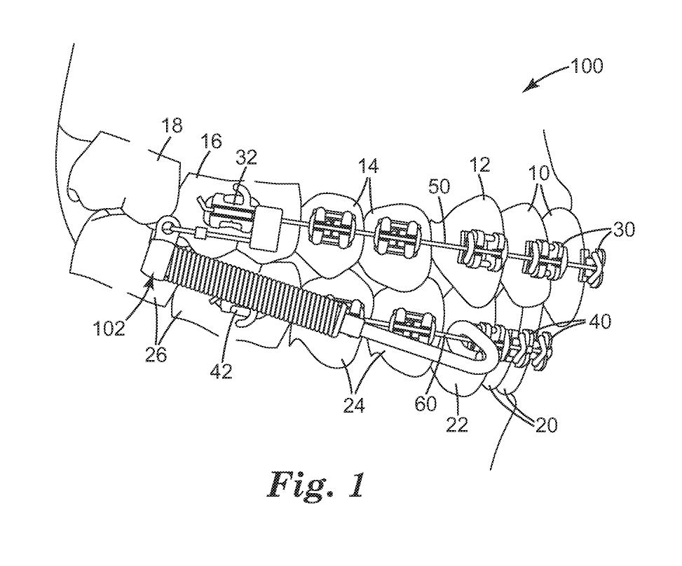

FIG. 1 depicts an orthodontic assembly according to one exemplary embodiment, broadly designated by the numeral 100. The assembly 100 represents the combination of orthodontic appliances installed on the right side of the upper and lower dental arches of a patient as shown. Located on the upper dental arch are a set of teeth, including upper anteriors 10, upper cuspid 12, upper bicuspids 14, upper first molar 16, and upper second molar 18. Similarly, the lower arch shows a set of teeth including lower anteriors 20, lower cuspid 22, lower bicuspids 24, and lower molars 26.

Bonded orthodontic appliances are affixed to the respective teeth of both the upper and lower arches. Appliances attached to the upper arch include upper brackets 30 and upper buccal tube 32. Similarly, appliances attached to the lower arch include lower brackets 40 and lower buccal tube 42. As shown in FIG. 1, each bracket and buccal tube includes a base for bonding the appliance to the facial surface of its respective tooth. As shown, each bracket further includes a slot for receiving an archwire with an opening oriented towards the facial direction.

Each of the upper appliances is connected to an upper archwire 50 and each of the lower appliances is connected to a lower archwire 60. In this example, both upper and lower archwires 50,60 have generally rectangular cross-sections in planes perpendicular to their longitudinal axes. An elastomeric O-ring ligature extends around each of the bracket tiewings to retain the respective archwire 50,60 in its archwire slot. Optionally, the distal ends of the archwires 50,60 are bent as shown in FIG. 1 in a location adjacent the distal side of the respective buccal tube 32,42. Alternatively, self-ligating appliances which use slidable doors, shutters, bales or clips may also be used.

While not shown, some embodiments of the invention include a mirror image configuration of assembly 100 similarly installed on the left side of the upper and lower dental arches. Such a configuration allows a symmetrical application of forces on both sides of the dental arch.

Orthodontic corrector 102 is part of the assembly 100 which couples the upper archwire 50 to the lower archwire 60. Optionally and as shown here, the corrector 102 is coupled on one end to the upper archwire 50 between the upper bicuspid brackets 30 and the upper buccal tube 32. As used herein, the “end” of a component, such as the corrector 102, shall mean a portion of the component adjacent its outermost end, and shall not be limited, for example, to an outermost end wall of the component. On the opposite end, the corrector 102 is coupled to the lower archwire 60 between the lower cuspid and lower bicuspid brackets 40. In the configuration shown, corrector 102 provides an expansion force bearing against the upper buccal tube 32 and the lower cuspid bracket 40. This expansion force in turn generates a therapeutic force that can correct an overbite by urging the lower dental arch in the forward direction relative to the upper dental arch.

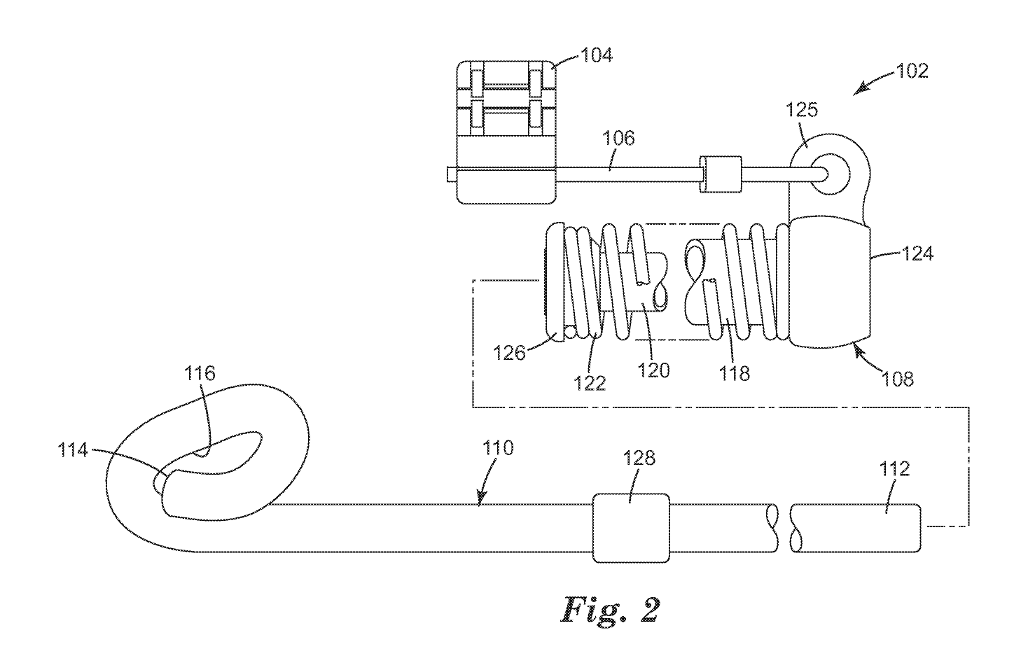

FIG. 2 illustrates the corrector 102 detached from the archwires 50,60 and viewed from the opposite direction (from the lingual side). As shown, the corrector 102 includes a connector 104 for coupling to the upper archwire 50. A cantilever 106 is coupled to the connector 104 at one end, and extends outwardly from the connector 104 in a generally distal direction. The opposite end of the cantilever 106 is coupled to a force module 108. As shown, the force module 108 has two opposing ends, with one end coupled to the cantilever 106 and the opposite end adapted for coupling to the lower archwire 60.

Preferably, the force module 108 is similar in many respects to the bite corrector described in U.S. Pat. No. 5,964,588 (Cleary). As exemplified in FIG. 2, the force module 108 includes a first elongated tubular member 118, a second elongated tubular member 120 that is received in the first member 118 in sliding, telescoping relation, and a third member 110 that is received in the second member. A helical compression spring 122 extends around the first tubular member 118 and has an outer end that bears against a distal end cap 124 fixed to the first member 118. The opposite end of the spring 122 bears against an annular fitting 126 that is secured to an outer end section of the second member 120. The third member 110 further includes an oversized stop 128 that engages the annular fitting 126 and limits the extent to which the third member 110 can be received into the second member 120.

The cantilever 106 is pivotally coupled to the force module 108 at attachment lug 125 which extends outwardly in a gingival direction from the distal end cap 124. At the opposite end of the force module 108, the outer mesial end of the third member 110 is formed into a loop-type configuration as shown in FIG. 2 for extending around a section of the lower archwire 60. Additional examples of loop-type configurations are set out in U.S. Pat. No. 6,669,474 (Vogt). Other constructions for connecting a force module to an orthodontic archwire are described in co-filed U.S. provisional patent application entitled “INTERARCH FORCE MODULE WITH LINK FOR ORTHODONTIC TREATMENT”, Ser. No. 61/168,946, filed on Apr. 13, 2009. In some embodiments, the outer end of the third member 110 also includes a line of weakness such as a recess or other area of reduced thickness for ease of bending the outer end section around the lower archwire 60. Examples of suitable commercially-available force modules 108 are included in the FORSUS brand fatigue resistant Class II correctors from 3M Unitek Corporation (Monrovia, Calif.).

When the connector 104 is connected to the archwires 50,60 in the manner described, the helical compression spring 122 urges the connector 104 and the third member 110 in directions away from each other. As a result, the connector 104 slides distally along the archwire 50 until it bears against the mesial side of the buccal tube 32, while the third member 110 slides mesially along the archwire 60 until it bears against the distal side of the bracket 40. Other aspects of operating the assembly 100 are similar to those of the appliance described in issued U.S. Pat. No. 6,558,160 (Schnaitter et al.).

The connector 104 and cantilever 106 of the assembly 100 may be used with other types of force modules as well, and its use need not be limited to telescopic force modules such as the force module 108 shown. For example, the cantilever 106 may be coupled to a flat spring made from a shape-memory alloy such as disclosed in issued U.S. Pat. No. 5,752,823 (Vogt). Likewise, the cantilever 106 may be coupled to any other resilient elongated body that is bendable in an arc about references axes perpendicular to its longitudinal axis, such as the force modules described in U.S. Pat. No. 5,651,672 (Cleary).

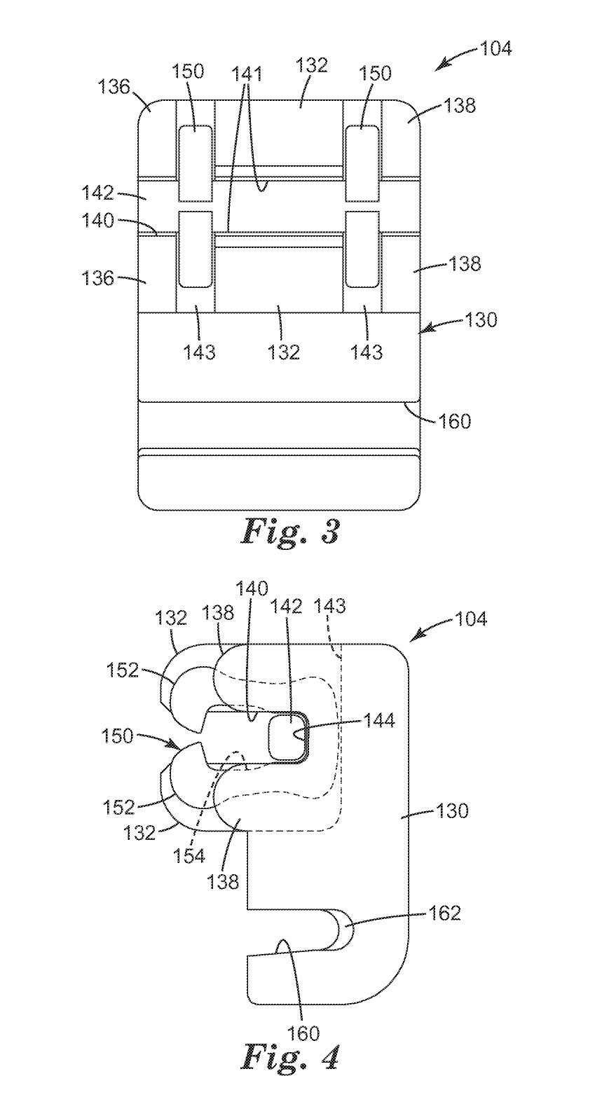

FIGS. 3-5 show the connector 104 as viewed from the lingual, distal, and occlusal directions, respectively. The connector 104 preferably shares some aspects with the connector component shown and described in copending U.S. provisional patent application entitled “ORTHODONTIC CONNECTOR PROVIDING CONTROLLED ENGAGEMENT WITH AN ORTHODONTIC WIRE”, Ser. No. 61/168,959, filed on Apr. 13, 2009.

As shown in these figures, the connector 104 includes a body 130. A pair of central posts 132, a pair of mesial posts 136, and a pair of distal posts 138 protrude outwardly from the body 130 towards a generally lingual direction. The central, mesial and distal posts 132,136,138 present aligned notches 144 which reside between each pair of posts 132,136,138. A pair of elongated grooves 143 extend across the lingual side of the body 130 in directions transverse to the notches 144 and are located in the spaces between the central and mesial posts 132,136 and between the central and distal posts 132,138. Optionally and as shown, the central, mesial and distal posts 132,136,138 are integral with the body 130.

A pair of resilient clips 150 are located in the grooves 143 and held captive by a retaining bar 142, which is received in the aligned notches 144 and extends along generally mesial-distal directions. The notches 144 thereby provide mating surfaces that allow the retaining bar 142 to precisely register with the body 130 when joined. In an exemplary method of assembly, the clips 150 are first placed in the grooves 143 of the body 130, the retaining bar 142 threaded through the clips 150, and finally the retaining bar 142 welded, soldered, or adhesively attached to the mating surfaces of the notches 144. The clips 150 have a mesial-distal width slightly smaller than the width of the grooves 143 to allow the clips 150 to flex freely.

The central, mesial and distal posts 132,136,138 and the retaining bar 142 collectively present an elongated archwire slot 140. As shown in FIG. 3, the archwire slot 140 extends in generally mesial-distal directions across the lingual side of the body 130 and is aligned with the pair of clips 150. The archwire slot 140 further has a generally “U”-shaped configuration in sections transverse to its longitudinal axis.

As seen from the distal direction in FIG. 4, each clip 150 has a generally “C”-shaped configuration and includes a pair of arm portions 152 that initially extend in lingual directions and then bend inwardly toward each other. Within each clip 150 is a wire-receiving region 154 aligned with the archwire slot 140. The pair of clips 150 are disposed adjacent to the respective mesial and distal sides of the connector 104 and releasably retain the archwire 50 in the archwire slot 140 when the assembly 100 is installed as shown in FIG. 1.

The clips 150 are shown in their normal, relaxed orientations in FIGS. 2, 3, and 4. However, the arm portions 152 of each clip 150 are movable away from each other in order to admit the archwire 50 into a wire-receiving region 154 when so desired. The smooth, outer edge of the arm portions 152 enables each clip 150 to receive the archwire 50 by first pressing the archwire 50 against the outer curved edges of the arm portions 152. As pressure is exerted by the archwire 50 on the curved edges, the arm portions 152 deflect away from each other in order to admit the archwire 50 into the wire-receiving region 154.

Once the archwire 50 is received in the wire-receiving region 154, the inherent resiliency of each clip 150 enables arm portions 152 to spring back toward each other and toward their normal, relaxed configuration as shown in FIGS. 2-4 to retain the archwire 50 in the archwire slot 140. In preferred embodiments, the archwire 50 is a rectangular archwire and the archwire slot 140 includes a pair of rigid and opposing walls 141 (see FIG. 3) that restrict relative rotation of the connector body 130 about the longitudinal axis of the archwire 50. In some embodiments, the wire-receiving region 154 is somewhat larger than the cross-section of the wire in directions along both an occlusal-gingival reference axis as well as along a facial-lingual reference axis, thereby avoiding firm contact between each clip 150 and the archwire 50.

Also located on the body 130 is an elongated crimpable slot 160, which extends across the body 130 in generally mesial-distal directions. As shown in FIG. 4, the crimpable slot 160 has a cross-section that is generally “U”-shaped when viewed in directions along the longitudinal axis of the crimpable slot 160. Alternatively, other cross-sectional shapes could also be used.

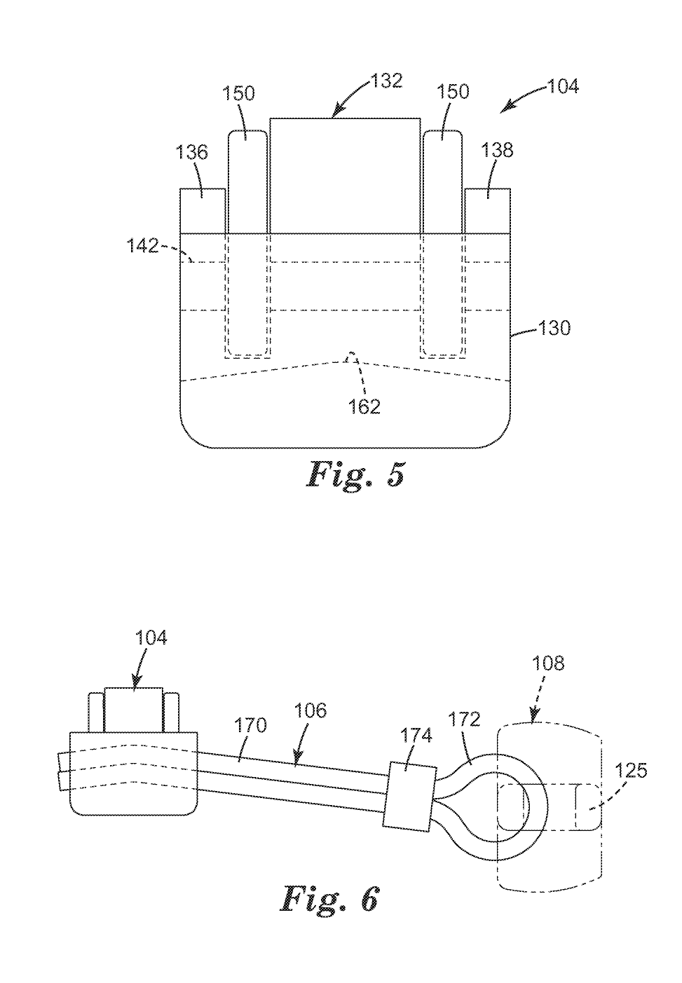

Optionally and as shown, the crimpable slot 160 has a slot bottom 162 that is non-parallel with the longitudinal axis of the archwire slot 140. This aspect is particularly shown by FIG. 5, in which the slot bottom 162 (denoted by dashed lines) is slightly inclined toward the lingual direction from the mesial and distal edges to the mesial-distal center of the crimpable slot 160. In this case, it is preferable that the mesial and distal taper of the slot bottom 162 is symmetrical about a reference plane that bisects the connector 104 into mesial and distal halves. This symmetry provides a manufacturing advantage, since it allows the same connector 104 to be used on either the left or right side of the dental arch.

FIG. 6 shows in more detail the cantilever 106 and the manner in which it is coupled to the adjoining connector 104 and the force module 108. In this exemplary embodiment, the cantilever 106 includes a single flexible wire 170 that is doubled back upon itself to form a closed loop 172 at the distal end of the cantilever 106. The flexible wire 170 has a configuration such that the closed loop 172 is threaded through the attachment lug 125 of the force module 108 to form a pivotal coupling.

Optionally and as shown in FIG. 6, the loop 172 is then secured using a collar 174. The collar 174 engages the doubled flexible wire 170 in encircling relation at a position adjacent to the loop 172 and is crimped into place to prevent undue sliding along the flexible wire 170. As an alternative, the collar 174 may also be welded, soldered, or adhesively fastened in place.

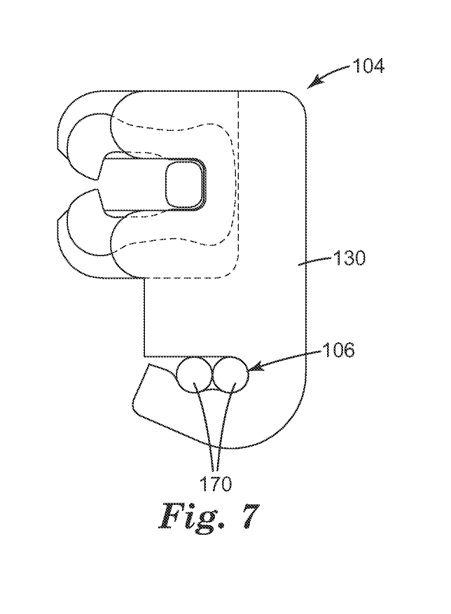

As further shown in FIG. 6, the doubled flexible wire 170 is received into the crimpable slot 160 of the connector 104. FIG. 7 shows a cross-section of the crimp coupling between the flexible wire 170 and the crimpable slot 160 as viewed from the distal direction. Preferably, the flexible wire 170 is fully seated into the crimpable slot 160 and assumes a shape that conforms with the tapered slot bottom 162 as shown in FIG. 6. In preferred embodiments, the flexible wire 170 crimped to the connector 104 such that the cantilever 106 is rigidly coupled and does not slide or rotate relative to the connector 104 during the course of treatment. The slot bottom 162 aligns the flexible wire 170 in a slight acute angle relative to the archwire slot 140 of the connector 104. As shown in FIGS. 2 and 7, the crimpable slot 160 is substantially closed when the cantilever 106 is secured to the connector 104.

As an alternative to crimp coupling the connector 104 and the cantilever 106, the two components may be joined by welding, soldering, adhesive bonding, or some other type of mechanical connection.

The cantilever 106 preferably comprises a flexible and resilient material that can withstand a significant amount of bending and twisting in response to forces transmitted from the force module 108 or even hard food objects during mastication. It is further preferable that the resilient material has sufficient memory to self-return the cantilever 106 to a certain, pre-determined orientation when relaxed (i.e. when external forces are removed). As shown here, the pre-determined orientation of the cantilever 106 is a generally straight orientation. Examples of suitable materials include, but are not limited to, shape-memory materials such as nickel-titanium alloys and the like. In exemplary embodiments, the cantilever 106 is made from a flexible wire 170 made from a nickel-titanium superelastic alloy and has a diameter of approximately 0.041 centimeters (0.016 inches).

The flexibility and resilience of the cantilever 106 significantly improve the robustness of both the orthodontic corrector 102 and the orthodontic assembly 100 as a whole. For one, these aspects allow the cantilever 106 to provide a flexible connection between the archwire 50 and the force module 108. Since the cantilever 106 resiliently deflects in a direction laterally of its longitudinal axis when external forces are encountered by the corrector 102, the transfer of mastication forces to the archwire 50 and the connector 104 is reduced. Advantageously, forces transferred to bonded appliances such as the brackets 30,40 and the buccal tubes 32,42 are similarly reduced, leading to fewer bond failures between these appliances and the patient's teeth.

Additionally, when the external forces are removed, the cantilever 106 springs back to its original orientation to ensure that the corrector 102 is once again properly aligned as depicted in FIG. 1. In this manner, the cantilever 106 flexibly maintains the distal end of the force module 108 in a location that is fixed relative to the connector 104 throughout the course of treatment. By maintaining proper and consistent alignment of the corrector 102 in the oral cavity, the likelihood of binding between couplings is also reduced, leading to fewer breakages between adjacent device components.

As an added benefit, the cantilever 106 positions the coupling between the loop 172 and the attachment lug 125 of the force module 108 in a location that is distal to the buccal tube 32. This provides a number of further advantages. First, positioning the coupling to the force module 108 distal, as opposed to mesial, to the buccal tube 32 provides a wider range of connection options between the corrector 102 and the lower dental arch. For example, this coupling creates sufficient space for the third member 110 to be alternatively coupled to the lower archwire 60 between the two lower bicuspid brackets 24 if desired by the orthodontist. This in turn can provide a Class II corrector with improved aesthetics since the third member 110 would be further hidden by the patient's cheeks. Even if this option is declined, positioning the coupling distal to the buccal tube 32 provides greater extension of the force module 108, which in turn expands the range of jaw motion over which the compression spring 122 can be activated.

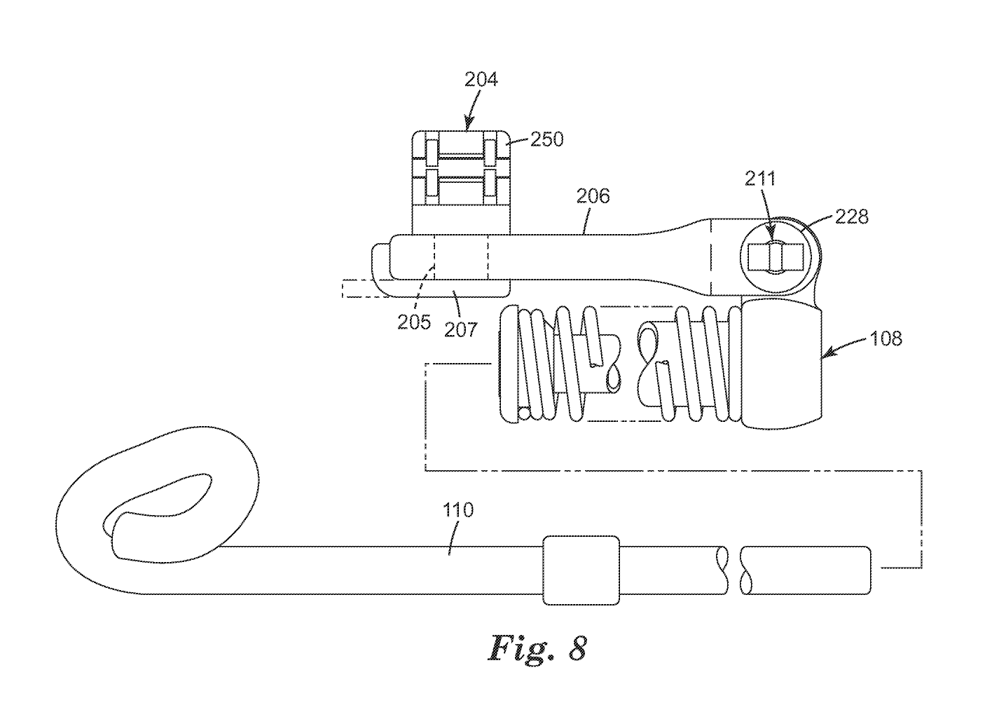

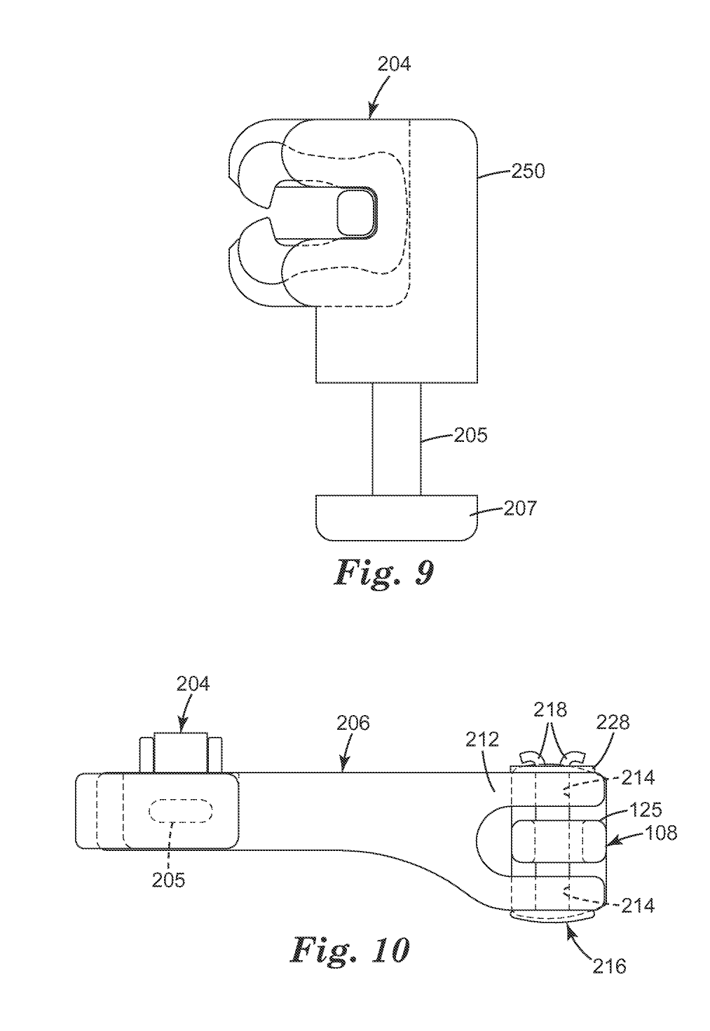

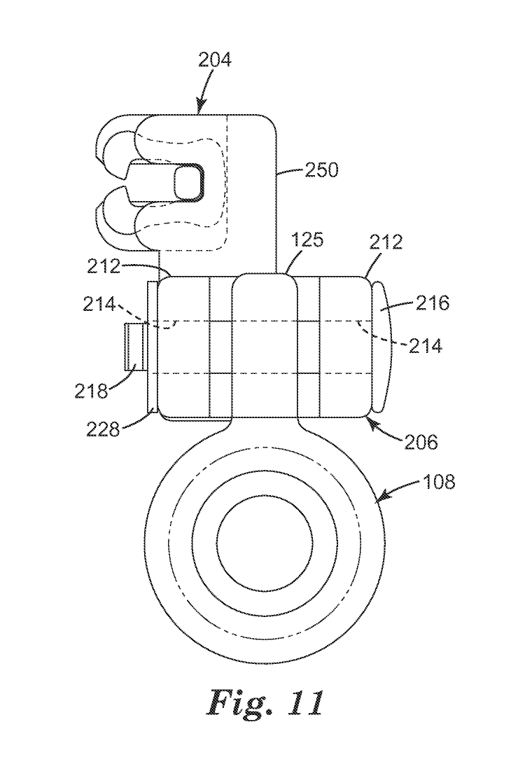

FIGS. 8-11 are directed to an alternative embodiment of the invention using a cantilever with a somewhat larger cross-section.

FIG. 8 shows an exploded view of an orthodontic corrector 202. Similar to the corrector 102, the corrector 202 has a connector 204 that includes a pair of resilient clips held captive within the connector 204 for reversably coupling to the upper archwire 50. As indicated by FIG. 8, the connector 204 also includes a body 250 and a generally elliptical post 205 (shown using dashed lines) extending from the body 250 in a generally occlusal direction and terminating in an oversized occlusal end cap 207. The post 205 extends through a complementally-shaped aperture in a cantilever 206 to couple the connector 204 to the cantilever 206 while rigidly coupling these components to each other. In some embodiments, the aperture in the cantilever 206 is slightly smaller than the cross-section of the post 205 so that there is a snug fit between the two components.

The cantilever 206 is secured against the body 250 by occlusal end cap 207. As shown by phantom lines in FIG. 8, the occlusal end cap 207 has an initially straight configuration. This straight configuration allows the cantilever 206 to be elastically stretched over the end cap 207 and onto the post 205 during assembly. The occlusal end cap 207 is subsequently bent at a right angle, as shown by the solid lines in FIG. 8. In this bent configuration, the end cap 207 extends along both occlusal and mesial edges of the cantilever 206 to prevent accidental disengagement.

Preferably and as shown, the cantilever 206 extends away from the connector 204 in a generally distal direction. On the distal end of the cantilever 206 is a pivotal joint 211 between the cantilever 206 and the force module 108 (which is identical to the force module 108 described in connection with the embodiment shown in FIGS. 1 and 2). As shown in FIG. 10, the distal end of the cantilever 206 includes a yoke 212, which straddles the attachment lug 125 of the force module 108. The yoke 212 includes a pair of aligned apertures 214, which are aligned with a through hole in the attachment lug 125. To assemble the pivotal joint 211, a split rivet 216 is inserted through the apertures 214 and the through hole in the attachment lug 125 and fastened in place by bending over a pair of rivet flanges 218. Optionally and as shown in FIGS. 8, 10, and 11, the rivet 216 also extends through a washer 228, which is interposed between the yoke 212 and the flanges 218. Preferably, the rivet 216 is sized to allow relative pivotal movement between the cantilever 206 and the force module 108 about the longitudinal axis of the rivet 216. Other aspects of the force module 108 have been already described and shall not be repeated here.

In some embodiments, the cantilever 206 comprises a resilient polymeric material such as a modified urethane or polyolefin. In alternative embodiments, the cantilever 206 comprises a high modulus elastomer such a highly crosslinked rubber, ethylene-propylene-diene monomer (EPDM) rubber, copolyester elastomer or fluoroelastomer. If additional stiffness or strength is desired, hard organic or inorganic fillers may be blended into the polymeric material. Cantilever 206 is preferably capable of significant twisting and bending deflection. In some embodiments, the cantilever 206 comprises a material having a flexural modulus ranging from 30 to 100 megapascals (4351-14504 pounds per square inch). It is further preferred that the cantilever 206 is durable and does not plastically deform during the course of treatment.

Other components of the assembly 100 and the correctors 102,202 may be manufactured according to any number of methods known to the skilled artisan. These methods include, but are not limited to, milling, investment casting, metal injection molding, and rapid prototyping. If desired, one or more of these parts can also be manufactured from other classes of materials, such as ceramics, polymers, or composites. If polymeric components are used, these may optionally be formed by milling, injection molding, extrusion or rapid prototyping.

In preferred embodiments, the individual correctors 102,202 are manufactured and provided to the orthodontist as a complete set. For example, the manufacturer may pre-assemble the connector 104, cantilever 106, and the force module 108 (excluding the third member 110) to minimize installation time by the orthodontist. The correctors 102,202 may further be packaged with an assortment of third members 110 with a range of sizes to fit a variety of patients.

In alternative embodiments, the cantilever 106,206 is connected directly to a bonded appliance such as an upper buccal tube or auxiliary wire segment.

In further alternative embodiments, one or more of the orthodontic correctors above are adapted to correct a Class III malocclusion. Such correction may be achieved, for example, by connecting the one end of the assembly to the archwire 50 between the upper cuspid 12 and upper first bicuspid 14 and the other end of the assembly to the archwire 60 distal to the lower first buccal tube 42. Similar configurations for treating Class III malocclusions are described in issued U.S. Pat. No. 6,558,160 (Schnaitter et al.). As before, the connections between components benefit from the increased robustness and functionality provided by the present invention.

All of the patents and patent applications mentioned above are hereby expressly incorporated by reference. The embodiments described above are illustrative of the present invention and other constructions are also possible. Accordingly, the present invention should not be deemed limited to the embodiments described in detail above and shown in the accompanying drawings, but instead only by a fair scope of the claims that follow along with their equivalents.

1. An orthodontic corrector for applying therapeutic forces between an upper arch appliance and a lower arch appliance comprising:
a connector for coupling to the upper arch appliance of a patient;
a cantilever rigidly coupled to the connector, the cantilever comprising a resilient material having sufficient memory to self-return the cantilever to a certain, pre-determined orientation when relaxed; and
a force module having two opposing ends, with one end coupled to the cantilever and the opposite end adapted for coupling to the lower appliance.

2. The orthodontic corrector of claim 1 wherein the pre-determined orientation of the cantilever is a generally straight orientation.

3. The orthodontic corrector of claim 2 wherein the cantilever extends in a generally distal direction when the corrector is coupled to the upper arch appliance and the lower arch appliance.

4. The orthodontic corrector of claim 1, wherein the upper arch appliance is an archwire and the connector further comprises:
a body;
a slot extending across the body; and
a clip coupled to the body, wherein the clip releasably retains the archwire in the slot and wherein the slot includes a pair of rigid and opposing walls that restrict relative rotation of the connector body about the longitudinal axis of the archwire.

5. The orthodontic corrector of claim 1, wherein the force module is pivotally coupled to the cantilever.

6. The orthodontic corrector of claim 1, wherein the resilient material comprises a shape-memory material.

7. The orthodontic corrector of claim 1, wherein the force module is a telescopic spring module.

8. The orthodontic corrector of claim 1, wherein the cantilever comprises a polymeric material having a flexural modulus ranging from 30 to 100 megapascals.

9. An orthodontic assembly comprising:
a set of brackets;
an archwire connected to the brackets;
a connector coupled to the archwire;
a cantilever rigidly coupled to the connector and comprising a resilient material having sufficient memory to self-return the cantilever to a certain, pre-determined orientation when relaxed; and
a force module coupled to the cantilever.

10. The assembly of claim 9, wherein the set of brackets includes an upper bicuspid bracket and an upper first molar bracket and further wherein the connector is coupled to the archwire between the upper bicuspid bracket and the upper first molar bracket.

11. The assembly of claim 10, wherein the cantilever extends outwardly from the connector in a generally distal direction to a location distal of the upper first molar bracket.

12. The assembly of claim 9, wherein the archwire is an upper archwire and further comprising a lower archwire, wherein the force module is coupled to the lower archwire.

13. The assembly of claim 9, wherein the resilient material comprises a shape-memory material.

14. A method of applying forces between first and second orthodontic appliances located on opposing jaws of a patient comprising:
providing a connector, the connector rigidly attached to one end of a cantilever comprising a resilient material having sufficient memory to self-return the cantilever to a certain, pre-determined orientation, the other end of the cantilever being pivotally attached to a force module;
coupling the connector to the first appliance; and
coupling the force module to the second appliance, wherein the cantilever flexibly maintains at least a portion of the force module in a location that is fixed relative to the connector.
